(19) United States
(12) Patent Application Publication
(10) Pub. No.: US 2008/0090443 A1
(43) Pub. Date: Apr. 17, 2008

(54) Carrying case for personal electronic appliance

(76) Inventor: Andrew Ackloo, Toronto (CA)

Correspondence Address: Mirek A. Waraksa, 1707-145 Marlee Ave., Toronto, ON, M6B 3-H3, CA

(21) Appl. No.: 11/580,276

(22) Filed: Oct. 13, 2006

(51) Int. Cl. H01R 4/50

(52) U.S. Cl. 439/346

(57) ABSTRACT

A carrying case permits a personal electronic appliance, such as an MP3 player, to be suspended from a user's person. In a particular embodiment, the carrying case comprises a housing, preferably formed of an elastomeric material, that receives the appliance, and a mounting assembly that suspends the housing, from a user's belt. The mounting assembly includes a pair of components joined by hand to simultaneously form a rotary joint and a detent mechanism. One component has a projection that interlocks with a recess in the other component to form the rotary joint. One component has a planar ratchet of circular configuration defined by shallow compartments formed in a planar face of the component, and the other component has a pawl that lodges in the ratchet, as the recess and projection interlock, to form the detent mechanism.

### FIELD OF THE INVENTION

The invention relates generally to carrying cases, and, more specifically, to cases designed to support personal electronic appliances such as MP3 players, cell phones, portable radios and the like, from a user's person.

### DESCRIPTION OF THE PRIOR ART

Portable MP3 players have become very popular as apparent from the commercial success of the iPod™ player marketed by Apple Corp. of Cupertino, Calif., U.S.A. This has spawned a demand for accessories for iPod™ players, particularly carrying cases.

One such carrying case, now prior art, has been marketed successfully in North America and Europe by iSkin Inc. of Toronto, Ontario, Canada. The carrying case has a housing formed of an elastomeric material, specifically a silicone. The housing is dimensioned to fit tightly about the exterior of an iPod™ player, protecting the player against scratching and accumulation of dirt and grime. The forward wall of the housing has an opening that allows viewing of the player's display, and a circular depression overlays touch-sensitive controls associated with the player. The depression reduces wall thickness locally to preserve the user's ability to operate the player by touch.

The prior art carrying case and others have employed a fastener adapted to fasten to the user's person and a mounting assembly that secures the fastener to the carrying case. The fastener may typically be a clip intended to fasten to a user's belt, and the mounting assembly may include a rotary joint that allows the carrying case to rotate relative to the clip. A detent mechanism resists such rotation when the clip and carrying case are in predetermined angular orientations relative to one another, allowing a desired orientation to be maintained. One object of the present specification is to provide a relatively compact mounting assembly that can be manually assembled from essentially two components.

### BRIEF SUMMARY OF THE INVENTION

In one aspect, the invention provides an improved kit of components adapted to form a carrying case for a personal electronic appliance. The kit includes a housing for receiving the appliance and means for suspending the housing from a user's person. The suspending means comprise a pair of components adapted to be joined by hand to simultaneously form a rotary joint that constrains the components to rotate relative to one another and a detent mechanism that resists such rotation when the components are in predetermined relative angular orientations, ultimately allowing the orientation of the housing to be adjusted relative to the user's person. A first of the components comprises an axis, a generally planar face perpendicular to the axis, and a recess formed in the generally planar face and centered about the axis. A second one of the components comprises a generally planar face and a projection perpendicular to its generally planar face and dimensioned for receipt in the recess of the first component.

The recess and the projection are shaped to interlock along the axis so as to resist relative axial separation but allow relative rotation about the axis, thereby forming the rotary joint. One of the first and second components has a generally planar ratchet defined by a multiplicity of compartments formed in the component's generally planar face. The compartments are equally spaced in a generally circular arrangement spanning a predetermined angle, 180 degrees in a preferred form. The other of the first and second components comprises a pawl fixed to the generally planar face of the other of the components and positioned to locate in one of the compartments of the ratchet, as the projection and recess interlock, thereby forming the detent mechanism. In preferred, the first component is integrally molded with both the recess and the ratchet, and the second component is integrally molded with both the projection and the pawl.

In another aspect, the invention provides a carrying case adapted to support a personal electronic appliance from a user's person. The carrying case comprises a housing shaped to receive the appliance with a forward wall of the housing overlaying a forward surface of the received appliance and a rear wall of the housing overlaying a rear surface of the received appliance. Means are provided to suspend the housing from the user's person, the suspending means comprising a plate-like member located within the housing against the rear wall, a pair of posts attached to the plate-like member and extending rearward parallel to one another through the rear wall of the housing, and a locking member that engages the posts. The locking member comprises a pair of clearance holes, each associated with and receiving a different one of the posts. The locking member having a generally planar rearward-facing surface, a rotational axis substantially perpendicular to the rearward-facing surface, and a recess formed in the rearward-facing surface and centered about the rotational axis.

The suspending means also comprise clip for attachment to an item of the user's clothing, typically to a user's belt. The clip may be integrally formed with forward and rear sections substantially parallel to one another. A forward one of the sections has a generally planar forward-facing surface confronting the rearward-facing surface of the locking member. It also comprises a projection substantially perpendicular to its forward-facing surface, aligned with the rotational axis, and received in the recess of the locking member. The recess and the projection comprising complementary radial profiles interlocked within the locking member itself to resist relative axial separation and to allow relative rotation of the locking member and the clip about the rotational axis.

Other aspects of the invention will apparent from a description below of preferred embodiments and will be more specifically identified in the appended claims. References to “forward-facing” and “rearward-facing” surfaces, and comparable expressions implying direction, should be understood with reference to general directions established by the forward and rear walls of the housing.

### DESCRIPTION OF THE DRAWINGS

The invention will be better understood with reference to drawings, in which:

FIG. 1 is a perspective view of a preferred embodiment of carrying case for a personal electronic appliance;

FIG. 2 is an exploded perspective view of the carrying case;

FIG. 3 is an exploded perspective view of a pad assembly whose support structure is integrally molded with two posts, and a locking member that engages the posts to lock the pad assembly against the rear wall of the housing;

FIG. 4 is a view showing the locking member in an initial angular orientation (shown in solid outline) in which the locking member receives one of the posts, and in a final locking orientation (shown in phantom outline) in which the locking member also receives the other post;

FIG. 5 is a fragmented view of the area designated 5 in FIG. 4 showing a rotary part used to secure the locking member in its locking orientation;

FIG. 6 is a section along lines 6-6 of FIG. 5 further detailing the construction of the rotary part; and,

FIG. 7 is an exploded cross-sectional further detailing various components of the carrying case.

### DESCRIPTION OF PREFERRED EMBODIMENTS

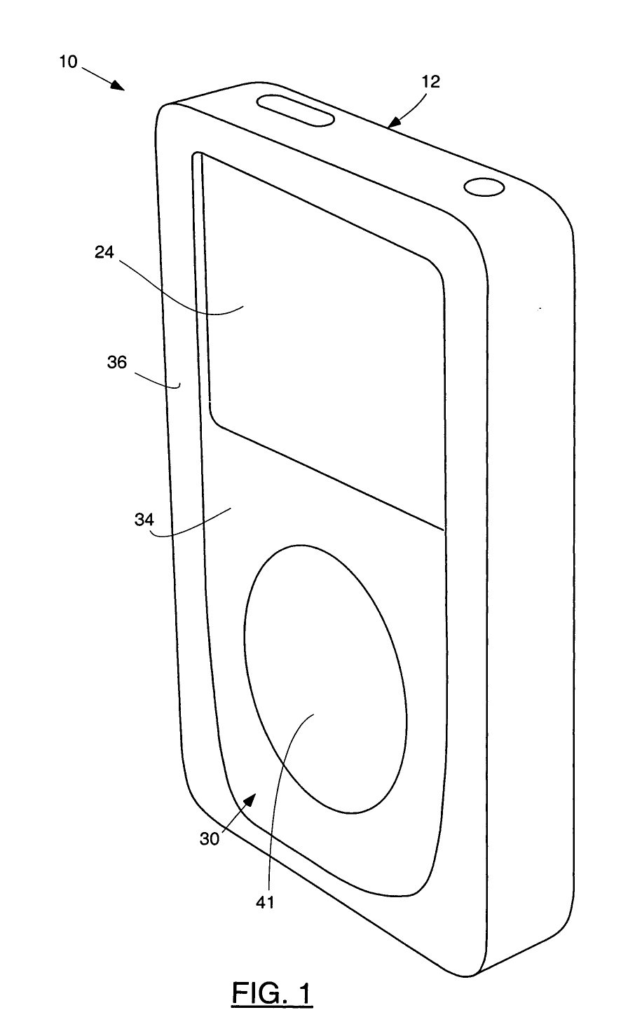

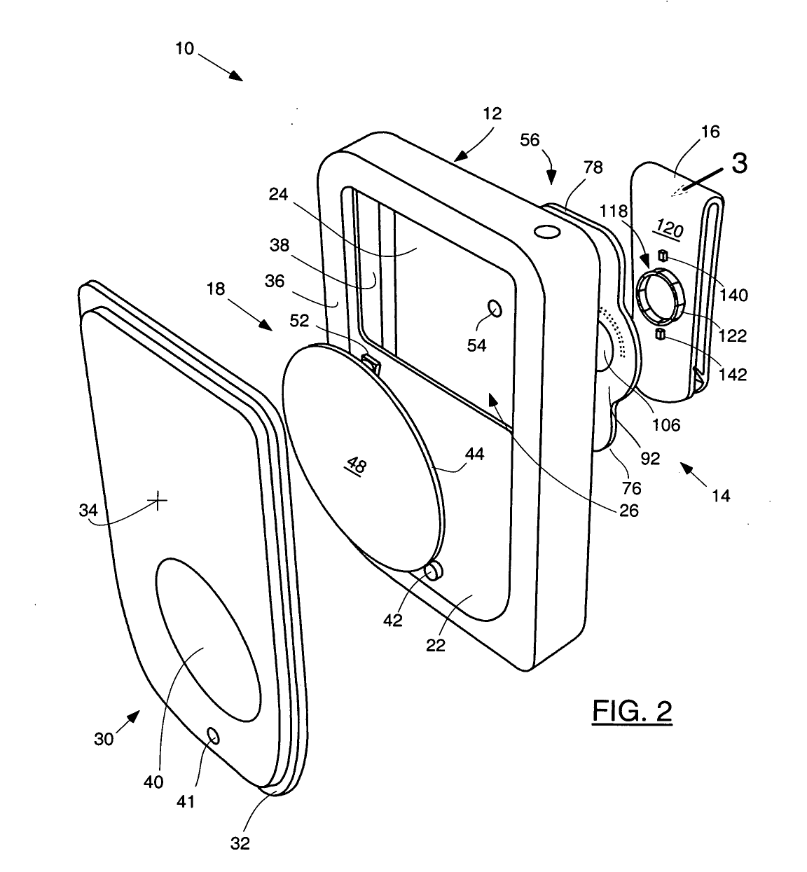

Reference is made to FIGS. 1 and 2 that illustrate a carrying case 10 intended to support a personal electronic appliance from a user's person. The case 10 includes an elastomeric housing 12 for receiving the appliance, a plastic clip 16 adapted to fasten to a user's belt, and a pad assembly 18 normally located inside the housing 12. A very compact assembly of components, described more fully below, couples the clip 16 to the pad assembly 18, defining both a rotary joint and a detent mechanism. The carrying case 10 will normally be supplied as a kit of components and assembled by the end user.

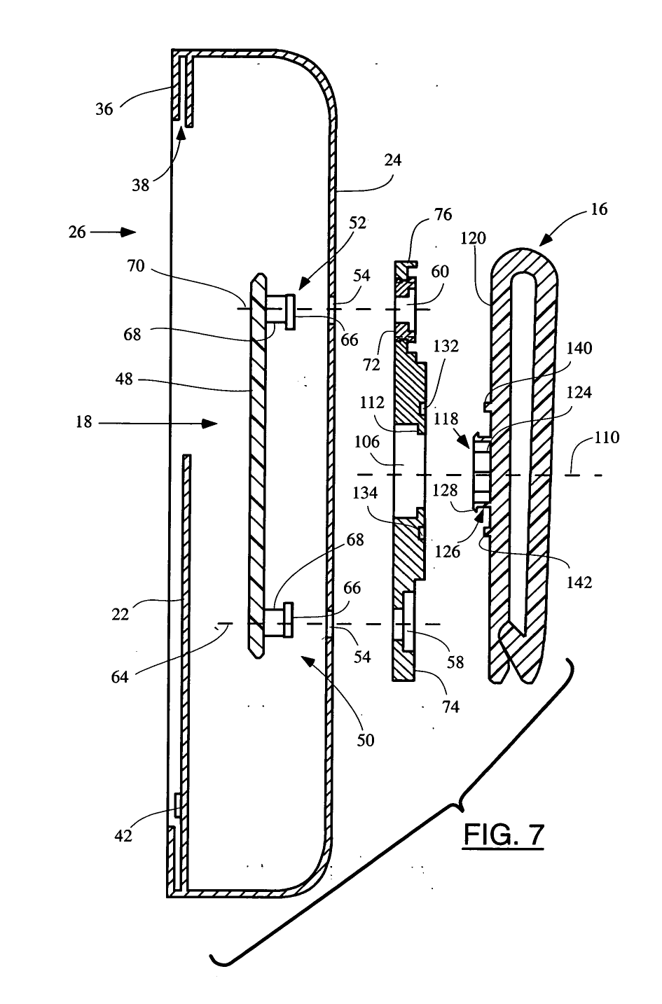

The housing 12 is integrally molded of a silicone and shaped to closely receive a particular personal electronic appliance, namely, the iPod™ MP3 player (not shown). The housing 12 has a forward wall 22 (shown in FIGS. 2 and 7) that normally overlays a forward surface of the received player, and a rear wall 24 (also shown in FIGS. 2 and 7) that normally overlays a rear surface of the received player. The player is inserted into or removed from the housing 12 through a generally rectangular access opening 26 formed in the forward wall 22 of the housing 12. The access opening 26 permits viewing of the received player's display, and the forward wall 22 may be molded relatively thin where it overlays touch-sensitive controls associated with the player. These aspects of the preferred embodiment are known in the prior art and consequently will not be described further.

The prior art carrying case discussed in the preamble of this specification has proven effective in preventing damage to a received player and reducing receipt and trapping of dirt. However, the access opening in the front wall of such prior art has been left uncovered in order to accommodate receipt and removal of a player, leaving the screen exposed and allowing fine debris to accumulate. This problem has been addressed in the construction of the present carrying case 10.

The housing 12 includes a transparent polycarbonate shield 30 that can be easily installed and removed to provide access to the received player. The shield 30 is shown in greater detail in FIG. 2 where it may be seen to comprise a circumferential mounting flange 32 that extends radially away from the thicker main body 34 of the shield 30. The housing 12 is integrally molded with a circumferential flange 36 substantially parallel to and overlaying the forward wall 22 (as apparent in FIG. 2 and the cross-sectional view of FIG. 7). The flange 36 cooperates with the forward wall 22 to define a circumferential groove 38 dimensioned to closely receive the mounting flange 32 associated with the shield 30. An opening 40 is formed in the shield 30 to permit operation of touch-sensitive controls. The shield 30 also has a small circular hole 41 that closely receives a generally circular alignment boss 42. The alignment boss 42 is integrally molded with the forward wall 22 of the housing 12, and cooperates with the hole 41 to align the shield 30 properly during installation. Once installed, the shield 30 protects the display associated with the player against direct contact and accumulation of dirt.

The elastomeric nature of the components reduces the need for tight manufacturing tolerances. More specifically, the circumferential groove 38 can be molded with an axial depth (measured between the flange 36 and the front wall of the housing 12) that is marginally smaller than the thickness of the mounting flange 32 of the shield 30. The circumferential flange 36 of the housing 12 simply deflects outward from the forward wall 22 to accommodate the thicker mounting flange 32.

The pad assembly 18 serves to reduce torques applied to the housing 12 that might otherwise be reacted into the rear wall 24 of the housing 12. The pad assembly 18 comprises a support structure 44 and a pad of gripping material adhered to the support structure to define a forward surface 48 of the pad assembly 18. The support structure 44 is a circular plate molded of polyethylene, and the pad is a thin layer of silicone in the order of several millimeters represented in the drawings solely by its surface 48.

The pad assembly 18 is mounted to the rear wall 24 of the housing 12 so that elastomeric tension arising upon installation of a player urges the forward surface 48 of the pad assembly 18 firmly into engagement with the rear surface of the received player. The degree to which the pad assembly 18 absorbs torques that would otherwise be reacted into the rear wall 24 of the housing 12 depends on several factors including the coefficient of friction between the pad assembly 18 and the rear surface of the received player, the distance of frictional forces from the center of the pad assembly 18, and the force with which the pad assembly 18 is urged against the rear surface of the received player. To enhance the ability of the pad assembly 18 to hold the received player stationary relative to the rear wall 24 of the housing 12, thereby reducing the likelihood of damage to the rear wall 24, the diameter of the pad should be fairly large. Although providing a diameter equal to 50% of the width of the housing 12 is regarded as a reasonable measure, it is preferred that the diameter of the pad approach the full width of the housing 12.

The assembly coupling the clip 16 to the pad assembly 18 includes a pair of identical posts 50, 52 integrally molded with the support structure 44 of the pad assembly 18. The posts 50, 52 are oriented parallel to one another and extend through openings 54 (shown in the exploded cross-section of FIG. 7) in the rear wall 24 of the housing 12. A locking member 56 external to the housing 12 is engaged with the posts 50, 52 to hold the pad assembly 18 against the rear wall 24 of the housing 12. To that end, the locking member 56 is formed with a pair of clearance holes 58, 60. When the locking member 56 is in the predetermined locking orientation 62 shown in phantom outline in FIG. 4, each clearance hole 58 or 60 receives an associated post 50 or 52, respectively.

In FIG. 7, the post 50 may be seen to comprise a central lengthwise axis 64, a radially expanded portion 66 external to the housing 12, and a radially narrow portion 68 that extends from the rear wall 24 of the housing 12 to the expanded portion 66. The expanded portion 66 is essentially a plate oriented perpendicular to the lengthwise axis 64 of the post 50 and having a generally triangular shape with rounded vertices. The associated clearance hole 58 has a similar triangular shape, but slightly larger, to allow axial receipt or removal of the expanded portion 66 of the post 50. It should be noted that, when the carrying case 10 is fully assembled, the expanded portion 66 is spaced a predetermined distance from the housing's rear wall 24, a distance sufficient to allow the locking member 56 to locate completely, preferably with minimal clearance, between the rear wall 24 of the housing 12 and the expanded portion 66 of the post 50. Components of the post 52 that are identical to those of the posts 50, specifically an enlarged portion 66 and a narrow portion 68, have been labeled with identical reference numbers. As indicated in FIG. 7, the post 52 has a central lengthwise axis designated with reference number 70.

The clearance hole 58 aligns with the expanded portion 66 of the associated post 50 for axial receipt or removal of the post 50 only in predetermined relative angular orientations. Technically only one such relative angular orientation is required; however, in this embodiment, which uses an equilateral triangle shape for aligning components, the expanded portion 66 of the post 50 aligns with the associated clearance hole 58 in three distinct relative angular orientations spaced 120 degrees apart. One such initial receiving orientation 71 is shown in solid outline in FIG. 4 and generally indicated with reference number. It should be noted for purposes of claim interpretation that the locking member 56 incidentally observes the same relative angular relationship with the post 50 as has been described with reference to its clearance hole 58 and in essence can be said to have the same aligning and non-aligning orientations relative to the post 50. The other post 52 and its associated clearance hole 60 share identical basic structure to the post 50 and clearance hole 58, their components have been labeled with identical reference numerals to share the foregoing description, and only differences will be described.

The clearance hole 58 is stationary relative to the rest of the locking member 56. To lock the post 50 to the locking member 56, the locking member 56 is installed about the post 50 in the initial receiving orientation 71 described above. The locking member 56 is then rotated about the narrow portion 66 of the post 50 until axially aligned with, but axially offset from, its final locking orientation 62, and the other clearance hole 60 overlays the other post 52. The change in angular orientation of the triangular clearance hole 58 between the two orientations should be noted. In the receiving orientation 71, the clearance hole 58 is aligned with the expanded portion 66 of the post 50. After axial alignment of locking member 56 with its the locking orientation 62 (phantom outline), the clearance hole 58 and the expanded portion 66 of the post 50 are misaligned, locking the post 50 to the locking member 56.

The other clearance hole 60 is formed in a rotary element 72 that is part of the locking member 56. When the clearance hole 60 has arrived at its position overlaying the post 52, as described in the preceding paragraph, the rotary element 72 is manually rotated to align the clearance hole 60 with the expanded alignment portion 66 of its associated post 52. The locking member 56 is then advanced axially along the post 52 until it seats against the rear wall 24 of the housing 12. To complete installation of the locking member 56, the rotary element 72 is simply rotated into non-alignment with the post 52. To release the locking member 56, the installations steps described above are simply reversed.

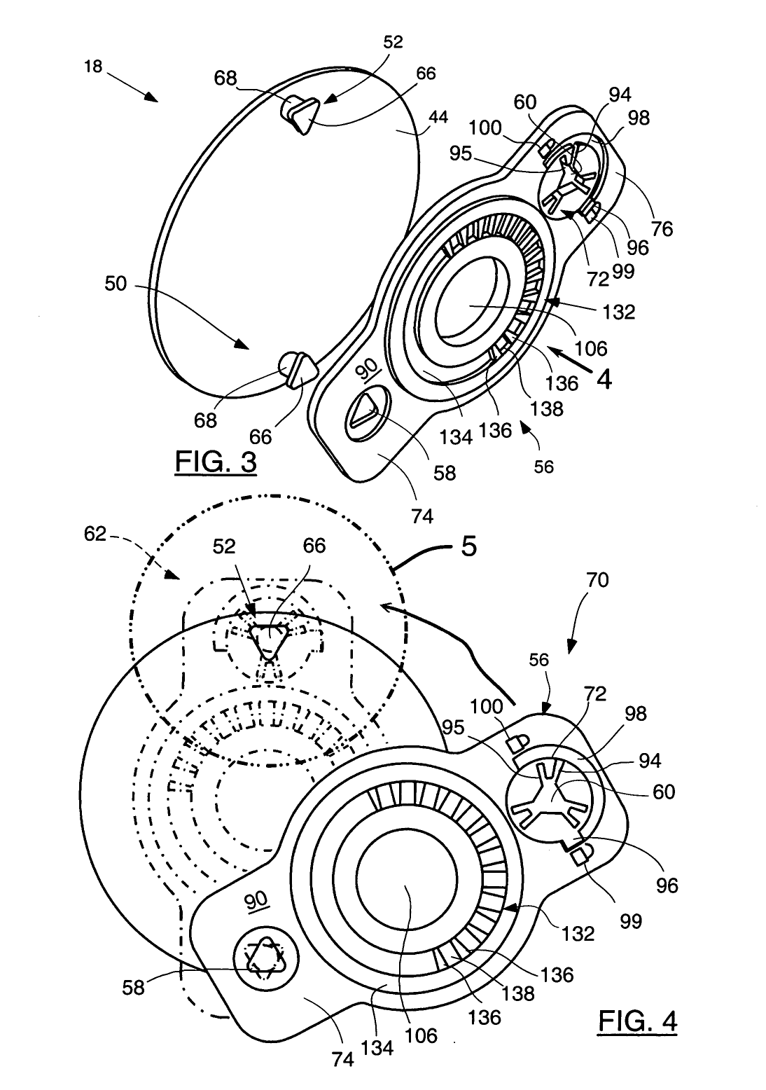

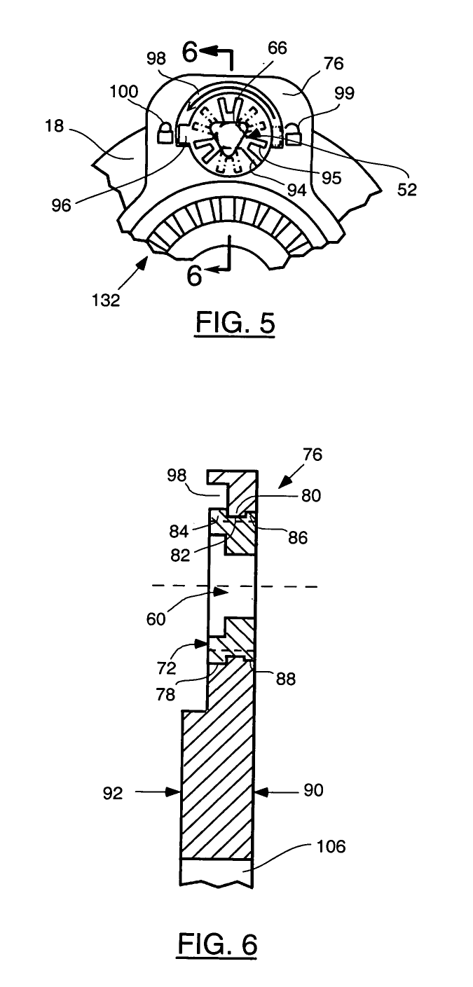

Details of the locking member 56 and its rotary element 72 are apparent in FIGS. 3-6. The locking member 56 is integrally molded with a pair of opposing planar mounting tabs 74, 76. One mounting tab 74 comprises the stationary clearance hole 58. The other mounting tab 76 comprises a generally circular opening 78 that receives the rotary element 72, and a circular flange 80 inside and extending around the generally circular opening 78. The periphery of the rotary element 72 has a circular groove 82 (shown in FIG. 6) shaped to receive and retain the circular flange 82 for relative rotation.

The circular groove 82 incidentally defines two annular flanges at the periphery of the rotary element 72: first, a relative large diameter flange 84 that seats against the internal flange 80; and second, a relative small diameter flange 86 that locates in an annular recess 88 surrounding the circular opening 78 and formed in a generally planar forward-facing surface/forward face 90 of the locking member 56. This arrangement is conducive to snap fitting the rotary element 72 into the circular opening 78. The smaller diameter flange 84 is simply inserted from the opposing, planar rearward-facing surface/rear face 92 of the locking member 56 and pushed until it snaps over the internal flange 80. During such snap fitting, the larger flange seats against the internal flange 80, arresting axial movement of the rotary element 72. To facilitate snap fitting, the rotary element 72 comprises six radially oriented grooves, each intersecting the clearance hole 60 and extending toward the periphery of the rotary element 72. One groove 94 extends fully to the periphery of the rotary element 72 while the other five grooves (only one such groove 95 specifically indicated in the drawings) terminate short of the periphery. The groove 94 permits contraction of the rotary element 72, and the other grooves relieve the stiffness of the rotary element'72 facilitating such contraction and consequently the snap fitting into the opening 78.

The rotary element 72 has a small tab 96 that permits the rotary element 72 to be manually rotated between its aligning and non-aligning orientations. The tab 96 travels in a part-circular recess 98 through an angle spanning about 180 degrees between extreme positions (hard stops). An icon 99, a representation of an open lock, is molded with the locking member 56 to indicate an aligning/unlocking orientation. In such an orientation, the clearance hole 60 can be aligned with the triangular expanded portion of the post 52, as shown in stippled outline in FIG. 4, for relative axial receipt or removal of the post 52. Another icon 100, a representation of a closed lock, is molded with the locking member 56 to indicate an opposing non-aligned/locking orientation in which axial separation of the locking member 56 and the post 52 is resisted.

A rotary joint is formed by components integrally molded with the clip 16 and with the locking member 56. As discussed more fully below, these components cooperate to allow the locking member 56 and the clip 16 to rotate relative to one another about a rotational axis 110 (shown only in FIG. 7) comprised by locking member 56 and oriented substantially perpendicular to the generally planar rear face 92 of the locking member 56. This ultimately allows the pad assembly 18 and housing 12 to rotate relative to the clip 16. As well, a detent mechanism is very conveniently integrated into the rotary joint to reduce the number of distinct components required, as discussed more fully below.

The locking member 56 has a generally cylindrical recess 106 formed in its generally planar rear face 92 and centered about the rotational axis 110. An annular internal mounting flange 112 is molded with the inner surfaces that otherwise define the recess 106 and also centered about the rotational axis 110. A projection 118 that cooperates with the mounting flange 112 is molded with, and substantially perpendicular to, the generally planar forward face 120 of the clip 16.

The projection 18 is a generally cylindrical structure with a central lengthwise axis coincident with the rotational axis 110 in FIG. 7 and consequently not separately shown. The projection 118 has an outer diameter corresponding generally to the inner diameter of the mounting flange 112, an axially forward end spaced from the clip 16, and an axially rearward end molded into the forward face 120 of the clip 16. Partial slits are formed in the cylindrical structure parallel to the central axis and equally spaced circumferentially, and one such slit 124 is specifically identified in FIG. 7. The slits together define a set of identical locking elements, one such locking element 126 being specifically identified in FIG. 7. The locking element 126 comprises a catch 128 that extends radially outward from the cylindrical structure and has a beveled forward surface.

To assemble the rotary joint, the projection 118 is axially aligned with the internal mounting flange 112 and pushed by hand into the central recess 106. It should be noted that the projection 118 and the recess have complementary radial profiles that allow the components to interlock against relative axial displacement yet rotate relative to one another about the axis 110. The beveled surfaces associated with the locking elements engage the rearward-facing annular surface of the internal flange 112 deflecting the locking elements radially inward to permit the projection 118 to pass through the central opening defined by the internal flange 112. The locking elements then snap radially outward, lodging their catches against the opposing annular, forward-facing surface of the mounting flange 112 and securing the rotary joint.

The detent mechanism comprises a planar ratchet 132 of generally circular configuration formed in the generally planar rear face 90 of the locking member 56. The ratchet 132 is centered about the rotational axis 110 and spans a sector of about 180 degrees. The ratchet 132 is defined by a circular groove 134 molded with the generally planar rear face 90 of the locking member 56 and a set of radially-directed ribs moulded in the groove 134. The ribs are equally spaced circumferentially, and each adjacent pair of radial ribs defines one of a set of identical recesses or shallow compartments. For example, the pair of adjacent ribs identified with reference number 136 in FIGS. 3 and 4 cooperates to define a recess or compartment 138. The forward face 120 of the clip 16 is molded with a pair of projections or pawls 140, 142 on diametrically opposite sides of the rotational axis 110 (spaced circumferentially by 180 degrees) and so positioned radially as to engage the ratchet 132 and the groove 134 as the rotary joint is assembled. The projection 140 is shown lodged in the recesses of the ratchet 132 to function as a pawl, resisting rotation of the pad assembly relative to the clip 16 at distinct angular intervals. The projection 142 conforms to and travels in the groove 134, stabilizing the ratchet 132 and pawl 140. This arrangement ensures that one projection 140 or 142 engages the ratchet 132 while the other projection 140 or 142 lodges in the unobstructed section of the groove 134 as the recess 106 and projection 118 interlock.

It will be appreciated that a particular embodiment of the invention has been described and that modifications may be made therein without necessarily departing from the scope of the appended claims.

I claim:

1. In a kit of components adapted to form a carrying case for a personal electronic appliance, the kit comprising a housing for receiving the appliance and means for suspending the housing from a user's person, the improvement in which the suspending means comprising a pair of components adapted to be joined by hand to simultaneously form a rotary joint that constrains the components to rotate relative to one another and a detent mechanism that resists such rotation when the components are in predetermined relative angular orientations thereby allowing the orientation of the housing to be adjusted relative to the user's person, in which:
a first of the components comprises an axis, a generally planar face oriented perpendicular to the axis, and a recess formed in the generally planar face and centered about the axis;
a second of the components comprises a generally planar face and a projection oriented perpendicular to the generally planar face of the second component and dimensioned to be received in the recess of the first component;
the recess and the projection are shaped to interlock along the axis so as to resist relative axial separation but allow relative rotation about the axis thereby forming the rotary joint;
one of the first and second components comprises a generally planar ratchet, the ratchet comprises a multiplicity of compartments formed in the generally planar face of the one component, and the compartments are equally spaced in a generally circular arrangement spanning a predetermined angle; and,
the other of the first and second components comprises a pawl fixed to the generally planar face of the other of the components and positioned to locate in one of the compartments of the ratchet as the projection and recess interlock thereby forming the detent mechanism.

2. The kit of claim 1 in which:
the recess is shaped to define an internal annular flange centered about the axis and a central opening circumscribed by the annular flange, and the flange comprises a pair of opposing annular faces;
the projection comprises a multiplicity of parallel elements spaced circumferentially to define a generally cylindrical structure, each of the elements has one end fixed relative to the generally planar face of the second component and an opposing end free to deflect radially relative to the generally planar face of the second component, and each of the free ends is formed with a catch that extends radially outward relative to the generally cylindrical structure; and,
the generally cylindrical structure is so shaped and dimensioned radially relative to the central opening that, during the interlocking of the projection and the recess, the catches deflect radially inward in response to contact with one of the annular faces of the flange thereby to pass through the circular opening, and then deflect radially outward thereby to lodge against the other of the annular faces of the flange.

3. The kit of claim 1 in which the ratchet is defined by structure integrally molded with the one component, the structure comprising:
a circular groove molded in the generally planar face of the one component; and,
a multiplicity of radial ribs molded in the circular groove, each adjacent pair of the radial ribs defining therebetween one of the compartments of the ratchet.

4. The kit of claim 3 in which:
the radial ribs span a sector of the circular groove of about 180 degrees, and the circular groove has another sector of about 180 degrees that is unobstructed;
the pawl is one of a pair of pawls molded with the other of the components, the pair of pawls spaced circumferentially by about 180 degrees such that, during the interlocking of the recess and the projection, one of the pawls locates in the ratchet while the other of the pawls locates in the unobstructed sector of the circular groove.

5. The kit of claim 1 in which the recess and the projection are dimensioned so that the generally planar face of the first component is drawn substantially into contact with the generally planar face of the second component as the projection interlocks with the recess thereby forming a compact rotary joint.

6. The kit of claim 1 in which:
the first component is integrally molded with both the recess and the ratchet; and,
the second component is integrally molded with both the projection and the pawl.

7. A carrying case adapted to support a personal electronic appliance from a user's person, the carrying case comprising:
a housing shaped to receive the appliance, the housing comprising a forward wall that overlays a forward surface of the received appliance and a rear wall that overlays a rear surface of the received appliance; and,
means for suspending the housing from the user's person, the suspending means comprising:
(a) a plate-like member located within the housing against the rear wall;
(b) a pair of posts attached to the plate-like member and extending rearward parallel to one another through the rear wall of the housing;
(c) a locking member comprising a pair of clearance holes, each of the clearance holes associated with and receiving a different one of the posts when the locking member is in a predetermined locking orientation, the locking member having a generally planar rearward-facing surface, a rotational axis substantially perpendicular to the rearward-facing surface, and a recess formed in the rearward-facing surface and centered about the rotational axis; and,
(d) a clip for attachment to an item of the user's clothing, the clip integrally formed with a pair of plate-like sections substantially parallel to one another, a forward one of the plate-like sections comprising a generally planar forward-facing surface confronting the rearward-facing surface of the locking member and comprising a projection substantially perpendicular to the forward-facing surface, aligned with the rotational axis and received in the recess of the locking member, the recess and the projection comprising complementary radial profiles interlocked within the locking member to resist relative axial separation and to allow relative rotation of the locking member and the clip about the rotational axis.

8. The carrying case of claim 7 in which:
each of the posts comprises a lengthwise axis, a radially expanded portion external to the housing, and a radially narrow portion that extends between the rear wall of the housing and the expanded portion;
the expanded portion of each of the posts is spaced a predetermined distance from the rear wall of the housing sufficient to permit the locking member to locate between the rear wall of the housing and the expanded portion of the post;
the narrow portion of each of the posts is dimensioned to permit the locking member to rotate about the axis of the post when the post is received by the associated clearance hole;
each of the clearance holes and the expanded portion of the associated post are shaped to align for axial receipt and removal of the associated post only in one or more predetermined relative angular orientations about the lengthwise axis of the associated post;
one of the clearance holes is stationary relative to the locking member and oriented such that, when the locking member is in its locking orientation, the one clearance hole is not aligned with the associated post thereby resisting axial removal of the received locking member from the associated post; and,
the other of the clearance holes is formed in a rotary element of the locking member that can be rotated manually about the axis of the associated post when the locking member is axially aligned with its locking orientation, between an angular orientation in which the other clearance hole aligns with the associated post and another angular orientation in which the other clearance hole is not aligned with the associated post.

9. The carrying case of claim 8 in which:
the locking member comprises a circular opening and a flange located within and extending circumferentially around the opening;
the rotary element comprises a generally circular peripheral groove in which the flange is received.

10. The carrying case of claim 8 in which the expanded portion of each of the posts is substantially a plate perpendicular to the axis of the post and having a generally triangular shape, and the associated clearance hole has a corresponding triangular shape.

11. The carrying case of claim 7 in which:
the recess of the locking member defines an internal annular flange centered about the axis and a central opening circumscribed by the flange, the flange comprises an annular face facing rearward toward the clip and an opposing annular face facing forward;
the projection comprises a multiplicity of parallel elements spaced circumferentially to define a generally cylindrical structure, each of the elements has one end fixed relative to the forward-facing surface of the clip and an opposing end free to deflect radially relative to the forward-facing surface of the clip, and each of the free ends is formed with a catch that extends radially outward relative to the generally cylindrical structure; and,
the generally cylindrical structure extends through the central opening circumscribed by the flange, and the catches are lodged against the forward-facing surface of the flange.

12. The carrying case of claim 7 in which:
the locking member comprises a generally planar ratchet, the ratchet comprises a multiplicity of compartments formed in the rearward-facing surface of the locking member, and the compartments are equally spaced in a generally circular arrangement centered about the rotational axis and spanning a predetermined angle; and,
the clip comprises a pawl fixed to the forward-facing surface of the one plate-like section and extending into one of the compartments of the ratchet.

13. The carrying case of claim 12 in which the ratchet is defined by structure integrally molded with the locking member, the structure comprising:
a circular groove molded in the rearward-facing surface of the locking member; and,
a multiplicity of radial ribs molded in the circular groove, each adjacent pair of the radial ribs defining one of the compartments of the ratchet.

14. The carrying case of claim 13 in which:
the radial ribs span a sector of the circular groove of about 180 degrees, and the circular groove has another sector of about 180 degrees that is unobstructed; and,
the pawl is one of a pair of pawls molded with the other of the components, the pair of pawls spaced circumferentially by about 180 degrees such that the one pawl is located in the ratchet and the other pawl is located in the unobstructed sector of the circular groove.
